(19) United States
(12) Patent Application Publication
(10) Pub. No.: US 2020/0026767 A1
(43) Pub. Date: Jan. 23, 2020

(54) SYSTEM AND METHOD FOR GENERATING TITLES FOR SUMMARIZING CONVERSATIONAL DOCUMENTS

(71) Applicant: FUJI XEROX CO., LTD., Tokyo (JP)

(72) Inventors: Francine Chen, Menlo Park, CA (US); Jian Zhao, Cupertino, CA (US); Yin-Ying Chen, San Jose, CA (US)

(73) Assignee: FUJI XEROX CO., LTD.

(21) Appl. No.: 16/038,086

(22) Filed: Jul. 17, 2018

(51) Int. Cl. G06F 17/30; G06N 3/08

(52) U.S. Cl. CPC G06F 17/30011; G06F 17/30719; G06N 3/08; G06F 17/30675; G06F 17/30696

(57) ABSTRACT

A method and system of generating titles for documents in a storage platform are provided. The method includes receiving a plurality of documents, each document having associated content features, applying a title generation computer model to each of the plurality of documents to generate a title based on the associated content features, appending the generated title to each of the plurality of documents, wherein the title generation computer model is created by training a neural network using a combination of a first set of unlabeled data from a first domain related to content features of the plurality of documents; and a second set of pre-labeled data from a second domain different from the first domain.

### BACKGROUND

### Field

The present disclosure relates to content summarization, and more specifically, to systems and methods for automatically summarizing content by automatically generating titles based on extracted content features.

### Related Art

There is an ever-increasing amount of textual information available to people. Often, the textual information may be unorganized and it may be difficult to determine how to prioritize what to look at. Further, many types of textual content, such as conversations and posts on enterprise chat, do not have a title or summary that may be used to easily organize or prioritize the information. For example, there is a torrent of information available to employees at a business. Rather than spending time sifting through the torrent, employee time may be better spent on other tasks.

One method for increasing browsing efficiency is to present the information in a compact form, such as using titles and incrementally revealing information only as a user indicates interest. However, related art methods of automatically creating such titles or summaries may suffer from a lack of sufficiently sized sets of text and corresponding titles to allow training of an automated system.

Further, obtaining good quality labeled data can be difficult and expensive. In some situations it may preferable that titles should be generated by the author to express the author's point, rather than by a reader. Some related art methods have attempted to train on data from another domain with author-generated titles, but because of differences between domains, the performance may be less than adequate. These differences may include different vocabularies, different grammatical styles, and different ways of expressing similar concepts. In the present application, addressing these differences in training a model across domains may improve performance.

### SUMMARY OF THE DISCLOSURE

Aspects of the present application may relate to a method of generating titles for documents in a storage platform are provided. The method includes receiving a plurality of documents, each document having associated content features, applying a title generation computer model to each of the plurality of documents to generate a title based on the associated content features, appending the generated title to each of the plurality of documents, wherein the title generation computer model is created by training a neural network using a combination of: a first set of unlabeled data from a first domain related to content features of the plurality of documents; and a second set of pre-labeled data from a second domain different from the first domain.

Additional aspects of the present application may relate to a non-transitory computer readable medium having stored therein a program for making a computer execute a method of generating titles for documents in a storage platform are provided. The method includes receiving a plurality of documents, each document having associated content features, applying a title generation computer model to each of the plurality of documents to generate a title based on the associated content features, appending the generated title to each of the plurality of documents, wherein the title generation computer model is created by training a neural network using a combination of: a first set of unlabeled data from a first domain related to content features of the plurality of documents; and a second set of pre-labeled data from a second domain different from the first domain.

Further aspects of the present application relate to a computing device including a memory storing a plurality of documents and a processor configured to perform a method of generating titles for the plurality of documents. The method including receiving a plurality of documents, each document having associated content features, applying a title generation computer model to each of the plurality of documents to generate a title based on the associated content features, appending the generated title to each of the plurality of documents, wherein the title generation computer model is created by training a neural network using a combination of a first set of unlabeled data from a first domain related to content features of the plurality of documents and a second set of pre-labeled data from a second domain different from the first domain.

Still further aspects of the present application relate to a computer apparatus configured to perform a method of generating titles for the plurality of documents. The computer apparatus including means for receiving a plurality of documents, each document having associated content features, means for applying a title generation computer model to each of the plurality of documents to generate a title based on the associated content features, means for appending the generated title to each of the plurality of documents, wherein the title generation computer model is created by training a neural network using a combination of a first set of unlabeled data from a first domain related to content features of the plurality of documents; and a second set of pre-labeled data from a second domain different from the first domain.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 illustrates a flow chart of a process 100 browsing and visualizing a collection of documents with automatically generated titles.

FIG. 2 illustrates a flow chart of a process 200 for training a title generation computer model used to generate titles of documents stored in a storage platform.

FIG. 3 illustrates a user interface (UI) 300 that may be used to display documents 310a-310d in accordance with an example implementation of the present application.

FIG. 4 illustrates another user interface (UI) 400 that may be used to display documents 310a-310d in accordance with an example implementation of the present application.

FIG. 5 illustrates a schematic representation of neural network model 500 in accordance with an example implementation of the present application.

FIG. 6 provides a graph of results of one experiment involving example implementations of the present application.

FIG. 7 provides a graph of results of a second experiment involving example implementations of the present application.

FIG. 8 illustrates an example computing environment with an example computer device suitable for use in some example implementations of the present application.

### DETAILED DESCRIPTION

The following detailed description provides further details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or operator control over certain aspects of the implementation, depending on the desired implementation of one of ordinary skill in the art practicing implementations of the present application. Further, sequential terminology, such as “first”, “second”, “third”, etc., may be used in the description and claims simply for labeling purposes and should not be limited to referring to described actions or items occurring in the described sequence. Actions or items may be ordered into a different sequence or may be performed in parallel or dynamically, without departing from the scope of the present application.

In the present application, the terms “document”, “message”, “text”, or “communication,” may be used interchangeably to describe one or more of reports, articles, books, presentations, emails, Short Media Service (SMS) message, blog post, social media post, or any other textual representation that may be produced, authored, received, transmitted or stored. The “document”, “message”, “text”, or “communication,” may be drafted, created, authored or otherwise generated using a computing device such as a laptop, desktop, table, smart phone, or any other device that may be apparent to a person of ordinary skill in the art. The “document”, “message”, “text”, or “communication,” may be stored as a data file or other data structure on a computer readable medium including but not limited to a magnetic storage device, an optical storage device, a solid state storage device, an organic storage device or any other storage device that may be apparent to a person of ordinary skill in the art. Further, the computer readable medium may include a local storage device, a cloud-based storage device, a remotely located server, or any other storage device that may be apparent to a person of ordinary skill in the art.

Further, in the present application the terms “title” “caption”, “textual summary”, or “text summary” may all be used interchangeably to represent a descriptive text-based summary that may be representative of the content of one or more of the described “document”, “message”, “text”, or “communication.”

In order to overcome the above discussed issues with the related art, example implementations of the present application may use a combination of vocabulary expansion to address different vocabularies in source and target domains, synthetic titles for unlabeled documents to capture the grammatical style of the two domains, and domain adaptation to merge the embedded concept representation of the input text in an encoder-decoder model for summary generation. Additionally, example implementations may also provide a user interface that presents summary information that first presents a concise version as titles which can then be expanded by a user.

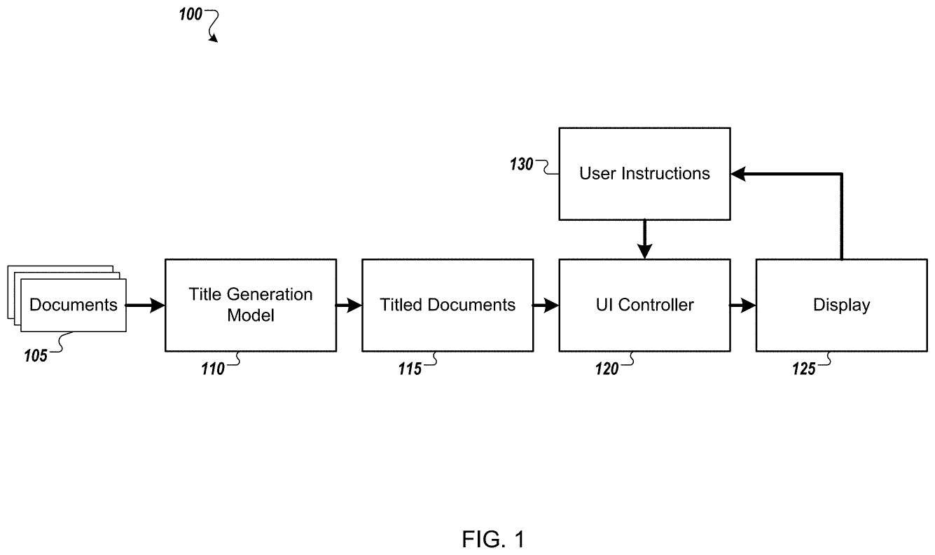

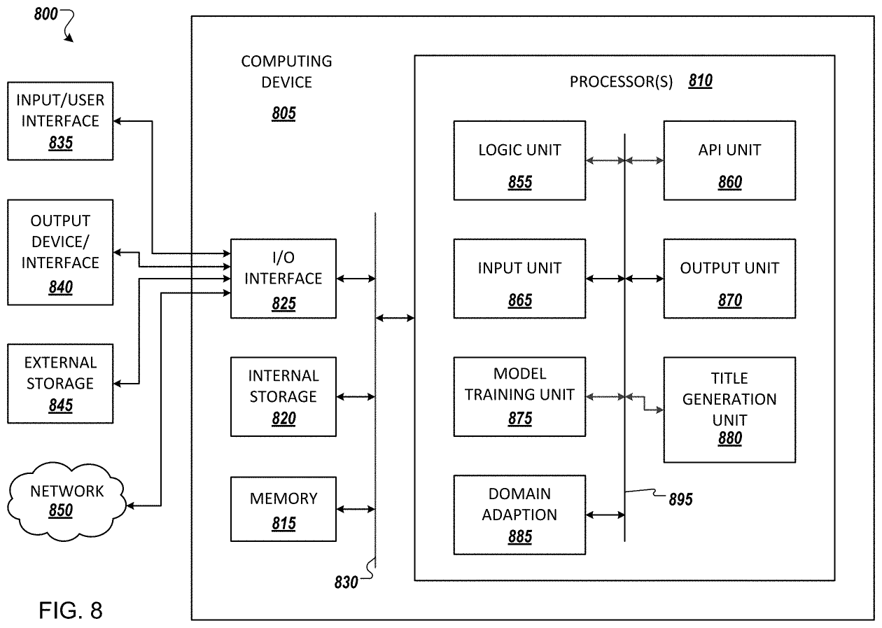

FIG. 1 illustrates a flow chart of a process 100 browsing and visualizing a collection of documents with automatically generated titles. The process 100 may be performed by a computing device in a computing environment such as example computing device 805 of the example computing environment 800 illustrated in FIG. 8 discussed below. Though the elements of process 100 may be illustrated in a particular sequence, example implementations are not limited to the particular sequence illustrated. Example implementations may include actions being ordered into a different sequence as may be apparent to a person of ordinary skill in the art or actions may be performed in parallel or dynamically, without departing from the scope of the present application.

As illustrated in FIG. 1, a plurality of documents are generated, stored, or received by the system at 105. Each of the plurality of document may include one or more content features that may be extracted using recognition techniques. For example, textual recognition may be used to extract words from the documents. In some example implementations, image recognition techniques may also be used to extract data representative of images from the documents. In some example implementations, the documents may be articles or papers stored in the research database. In other example implementations, the documents may be chat messages, instant messages, chat board postings, or any other type of document that might be apparent to a person of ordinary skill in the art. In some example implementations, a detangling process may be performed to separate threads of messages based on content features.

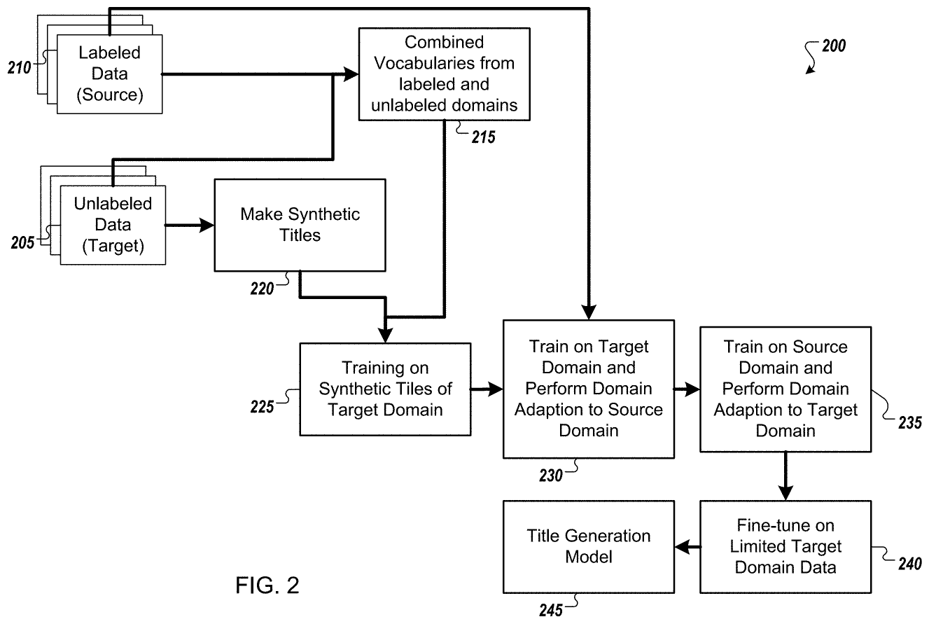

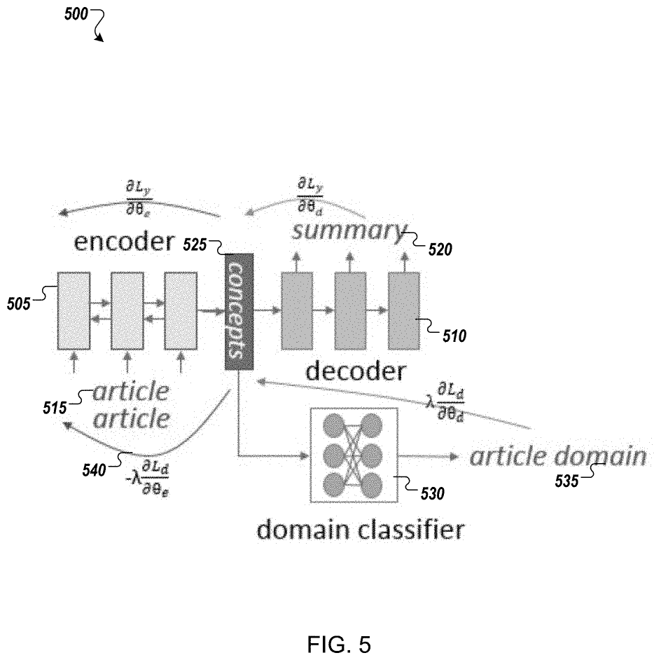

At 110, a title generation computer model is applied to each of the documents to generate a title or other short summary. The title generation model may be a neural network configured to use the content features extracted from each document to generate the title or short summary based on previous training. The neural network architecture is discussed in greater detail below with respect to FIG. 5. The training of the neural network is discussed in greater detail with respect to FIG. 2.

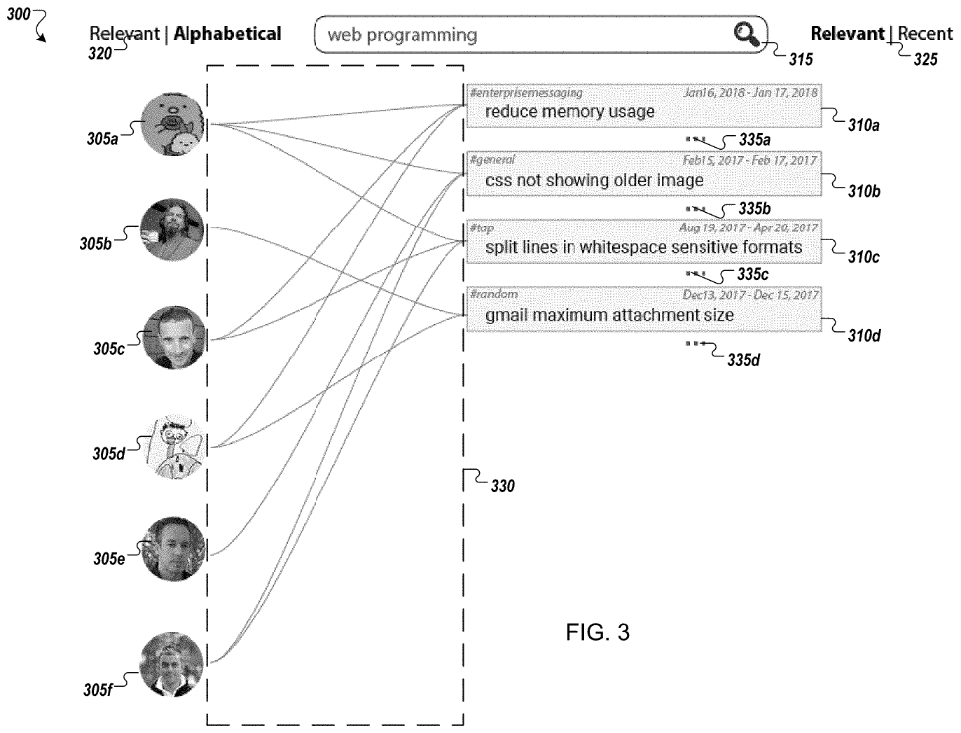

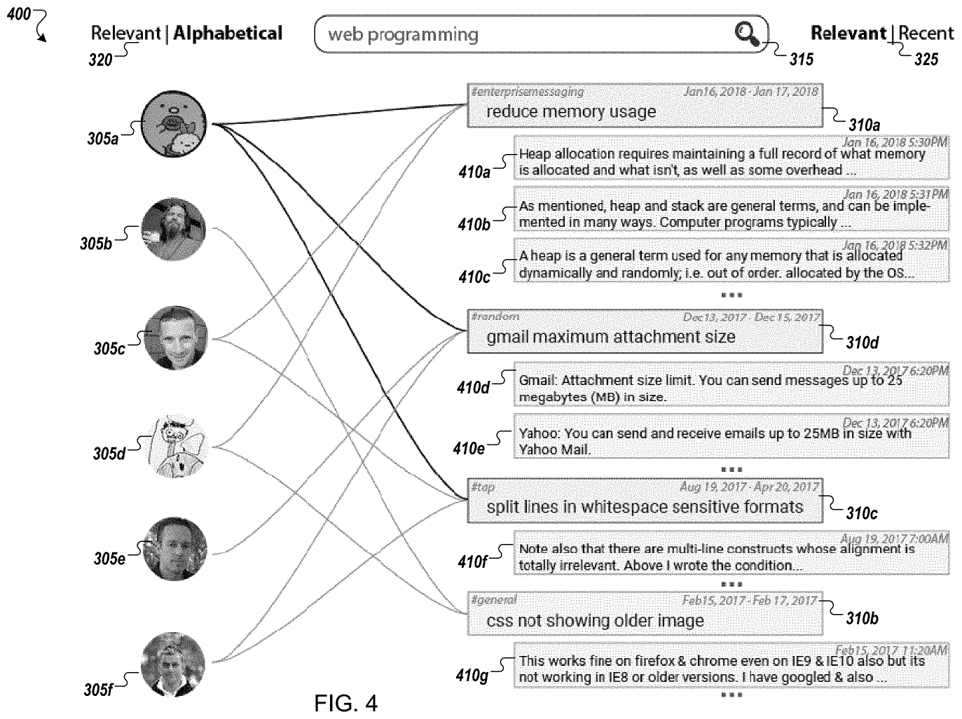

After titles or short summaries have been generated for each of the documents, the documents and titles are provided to a User Interface Controller at 120. The User Interface Controller generates a User Interface (UI) display including one or more of the documents, based on the titles or short summaries at 125. Example implementations of the UI are discussed in greater detail below with respect to FIGS. 3 and 4 below.

After the UI is displayed, a user may interact or provide control instructions at 130. For example, the user may provide a search request or select one or more displayed documents. The User instructions at 130 are fed back into the UI controller at 120 and a new display is generated at 125. Again, example implementations of the UI are discussed in greater detail below with respect to FIGS. 3 and 4 below. The UI may be continually updated by the repeating 120-130 as needed.

FIG. 2 illustrates a flow chart of a process 200 for training a title generation computer model used to generate titles of documents stored in a storage platform. The process 200 may be performed by a computing device in a computing environment such as example computing device 805 of the example computing environment 800 illustrated in FIG. 8 discussed below. Though the elements of process 200 may be illustrated in a particular sequence, example implementations are not limited to the particular sequence illustrated. Example implementations may include actions being ordered into a different sequence as may be apparent to a person of ordinary skill in the art or actions may be performed in parallel or dynamically, without departing from the scope of the present application.

As illustrated in FIG. 2, the training of title generation computer model involves using two training data sets. In some example implementations first training data set 205 is unlabeled data from a first (target) domain and second training data set 210 is pre-labeled data from a second (source) domain. For example, training data set 205 could be unlabeled posts to an internal company chat or messaging platform with a bias toward business related domains and training data set 210 may be labeled articles or stores posted to a news platform providing general interest stories (general interest domain).

At 215, vocabularies extracted from the first training data set 205 and from the second training data set 210 may be combined to produce a single vocabulary. In other words, to handle differences in vocabulary, the vocabulary of the labeled data (source) 210 and unlabeled data (target) domains are combined. For example, the union of the 50 k most frequent terms from the training data of each domain (e.g., the domain of the first training data set 205 and the domain of the second training data set 210)) may produce a vocabulary of about 85 k terms due to repetition of common terms between the two data sets.

Further, the grammatical structure of the unlabeled (target) data may be different from the labeled (source) data. For example, the grammar of the unlabeled posts to an internal company chat may be more casual than news articles. To capture the grammar of the target data, titles are synthesized. For example, to capture the grammatical structure of the unlabeled data set (target data set) 205, “synthetic” or preliminary titles may be generated by selecting the first sentence of the post with a sentence length of between a minimum and maximum number of words at 220. For example, a minimum of 4 words and a maximum of 12 words may be used. Other minimums and maximums may be used in other example implementations. In this way, both the encoder and decoder of a neural network may be trained on text from the target domain, although the titles will generally be incorrect. In some example implementations, the selected “titles” from the first sentence were replaced with a later “title” (e.g., occurring later in the document) 10% of the time to make the task more difficult for the decoder. In some example implementations, synthetic data is used to train a decoder (on grammar) rather than an encoder for a classifier.

At 225, the set of “synthetic” or preliminary titles for the unlabeled target domain is first used to train a neural network to develop a model using the combined expanded vocabulary from 215. In some example implementations, a sequence-to-sequence encoder-decoder model may be used to generate a title. In some example implementations, a coverage part of the model may not be included to help to avoid repetition of words. The embedded representation generated by the encoder may be different for each domain.

Thus, at 230 an embedding space of the trained model may then adapted to the source domain using adversarial domain adaptation (ADA) to align the embedded representation for different domains. For example, a classifier may be employed to forces the embedded feature representations to align by feeding the negative of the gradient back to the feature extractor. In other words, the embeddings may be treated as “features” and the gradient from the classifier may be altered during back-propagation so that the negative value is fed back to the encoder, encouraging the embedded representations to align across different domains. FIG. 5 discussed below shows an encoder-decoder model with domain adaptation in accordance with example implementations.

With a joint embedding space defined, the model is re-trained at 235 on the source domain, which has title-text pairs, and the unlabeled target domain is used as the auxiliary adaptation data for a secondary classification task to keep the model embedding aligned with the target data. For example, the labeled data may be fed to the encoder and the decoder learns to generate titles. At the same time, unlabeled data is also fed to the encoder and the classifier tries to learn to differentiate between data from the two domains.

After re-training at 235, the model can then be fine-tuned using a limited amount of labeled target data at 240 if higher accuracy is needed and the title generation computer model at 245. After the title generation computer model has been generated, the process 200 ends.

FIG. 3 illustrates a user interface (UI) 300 that may be used to display documents 310a-310d in accordance with an example implementation of the present application. The UI 300 may be displayed on a display device including, but not limited to, a computer monitor, TV, touchscreen display of a mobile device, a laptop display screen, or any other display device that may be apparent to a person of ordinary skill in the art. In the UI 300, the documents 310a-310d is illustrated as chat messages or instant messages on a messaging platform. However, other types of documents may be used as part of the UI 300.

As illustrated, the UI 300 includes a plurality of user icons 305a-305f associated with individual users of the chat platform. The UI 300 also includes a search bar or other control interface 315. After an end-user initiates a search, for example, “web programming”, in the search bar, a list of results (documents 310a-310d) are displayed with relevant user icons 305a-305f on the left and documents 310a-310d on the right (FIG. 3). The users are shown as user icons 305a-305f, and the documents 310a-310d are shown as text snippets with the generated titles summarizing the corresponding contents. Some meta-data information such as channel names and timespans may also be indicated on each document documents 310a-310d. Relationships between the users and the conversations (e.g., who is involved in which conversations) are represented as links (highlighted by broken line box 330) in the middle section.

In addition, UI 300 also includes control links 320 and 325 that can be used to can reorder the user icons 305a-305f or the conversations 310a-310d by a variety of criteria (e.g., relevancy, time, and alphabetically). Further, an end-user can expand certain conversations by clicking one of the “ . . . ” buttons 335a-335d, which gradually reveals individual messages within those conversations (illustrated in FIG. 4 discussed below).

FIG. 4 illustrates another user interface (UI) 400 that may be used to display documents 310a-310d in accordance with an example implementation of the present application. The UI 400 may have feature similar to those discussed above with respect to FIG. 3 and similar reference numerals may be used for similar features. Again, the UI 400 may be displayed on a display device including, but not limited to, a computer monitor, TV, touchscreen display of a mobile device, a laptop display screen, or any other display device that may be apparent to a person of ordinary skill in the art. In the UI 400, the documents 310a-310d is illustrated as chat messages or instant messages on a messaging platform. However, other types of documents may be used as part of the UI 400.

Again, the UI 400 includes a plurality of user icons 305a-305f associated with individual users of the chat platform. The UI 400 also includes a search bar or other control interface 315. After an end-user initiates a search, for example, “web programming”, in the search bar, a list of results (documents 310a-310d) are displayed with relevant user icons 305a-305f on the left and documents 310a-310d on the right. The users are shown as user icons 305a-305f, and the documents 310a-310d are shown as text snippets with the generated titles summarizing the corresponding contents. Some meta-data information such as channel names and timespans may also be indicated on each document documents 310a-310d. Relationships between the users and the conversations (e.g., who is involved in which conversations) are represented as links (highlighted by broken line box 330) in the middle section.

In addition, UI 400 also includes control links 320 and 325 that can be used to can reorder the user icons 305a-305f or the conversations 310a-310d by a variety of criteria (e.g., relevancy, time, and alphabetically). Further, an end-user can expand certain conversations by clicking one of the “ . . . ” buttons 335a-335d, which gradually reveals individual messages 410a-410g within those conversations as illustrated in FIG. 4. Additionally, a user may select one or more specific users (e.g., 305a), and related conversations 310a, 310d, and 310c may be highlighted (in yellow) and brought to the top of the list.

By first displaying the search results based on generated titles, a user may be allowed to browse a large amount of information more effectively. The user can then choose the most interesting results to explore further by expanding the conversations. As the generated titles summarize large chunks of text, it may the user significant time to read and go through the results. Unlike traditional ways of showing search results just in a ranked list, the UIs 300 and 400 may enable a richer exploration, such as investigating relationships between users and conversations, reordering results, and expanding items for details, which may be important for browsing complicated enterprising messaging data.

FIG. 5 illustrates a schematic representation of neural network model 500 in accordance with an example implementation of the present application.

As illustrated, the neural network model 500 is an encoder-decoder RNN model with domain adaptation. Labeled source data (articles 515) is fed to the encoder 505 and the decoder 510 learns to generate summary titles (summary 520). At the same time, the source data and unlabeled target domain data are encoded and from their concept representations 525, the domain classifier 530 tries to learn to differentiate between the two domains 535.

In some example implementations, the domain classifier 530 may have two dense, 100-unit hidden layers followed by a softmax. The concept representation 525 vector is computed as the bidirectional LSTM encoder's final forward and backward hidden states concatenated into a single state. Further, the gradient 54 from the classifier 530 during back propagation may be “reversed” to be negative before being propagated back to through the encoder 505, encouraging the embedded representations to align by adjusting the feature distributions to maximize the loss of the domain classifier 530.

Further, the generated sequence loss together with the adversarial domain classifier loss may be defined by equation 1 below:

$$loss = \frac{1}{T} {\sum }_{t = 0}^{T} {L}_{g} ( t ) - λ {L}_{d} \qquad ( Equation 1 )$$

where, the decoder loss L_{y}(t)=−log P(ωₜ*) is the negative log likelihood of the target word ωₜ* at position t. The domain classifier loss, L_{d}, is the cross-entropy loss between the predicted and true domain label probabilities.

Evaluation Results

Inventors have conducted multiple experiments to investigate how well the different methods perform when no labeled data is available.

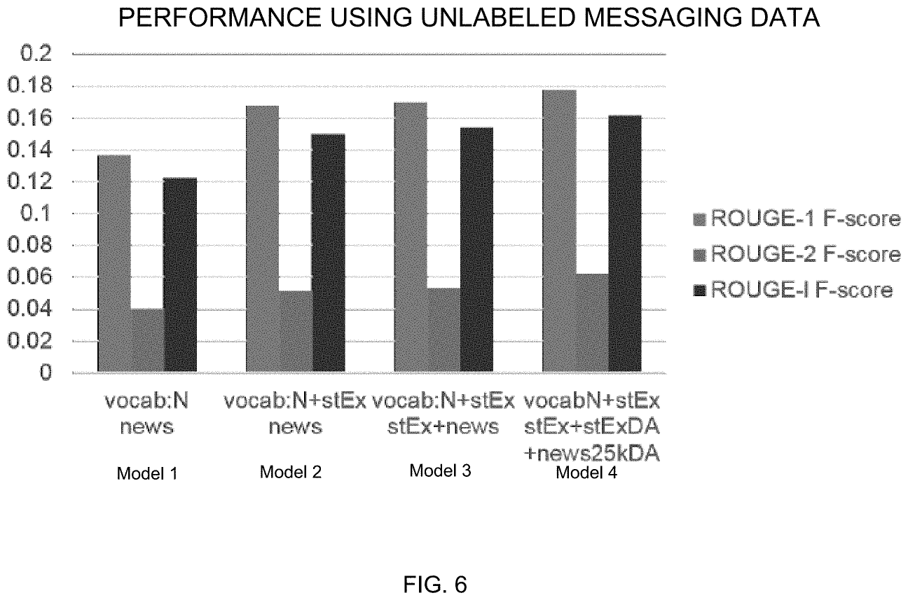

FIG. 6 provides a graph of results of one experiment involving example implementations of the present application. As illustrated, performance of various models for generating titles for unlabeled messaging data in a chat platform. The models compared from left to right are:

(1) a baseline model using a news vocabulary trained on news articles and titles;

(2) a model with an expanded, combined vocabulary of the most frequent terms from both the training news data and the unlabeled messaging data (stEx data);

(3) model 2 trained on real unlabeled messaging data with synthetic Stack Exchange titles, then trained on news data;

(4) model 2, except rather than training directly on news, first domain adaptation is used to adapt the synthetic Stack Exchange data and news data. Then domain adaptation is embedded representations aligned for the two domains.

TABLE 1
First Experimental results illustrated in FIG. 6

| | | ROUGE-1 | ROUGE-1 | ROUGE-1 |
|---|---|---|---|---|
| Vocabulary | Training Data | F-score | F-score | F-score |
| vocab: News | | 0.1365 | 0.0402 | 0.1227 |
| vocab: News + | News | 0.1678 | 0.0513 | 0.15 |
| stEx | | | | |
| vocab: News + | sStEx + news | 0.1699 | 0.0534 | 0.1538 |
| stEx | | | | |
| Vocab: News + | sStEx + sStExDA + | 0.1778 | 0.0622 | 0.1615 |
| stEx | news25kDA | | | |

From FIG. 6 and Table 1 above, it can be observed that adding each of the methods improves the performance in varying amounts. The overall improvement over using a model trained with the news vocabulary on news data to generate titles when using a combination of the methods is 30%.

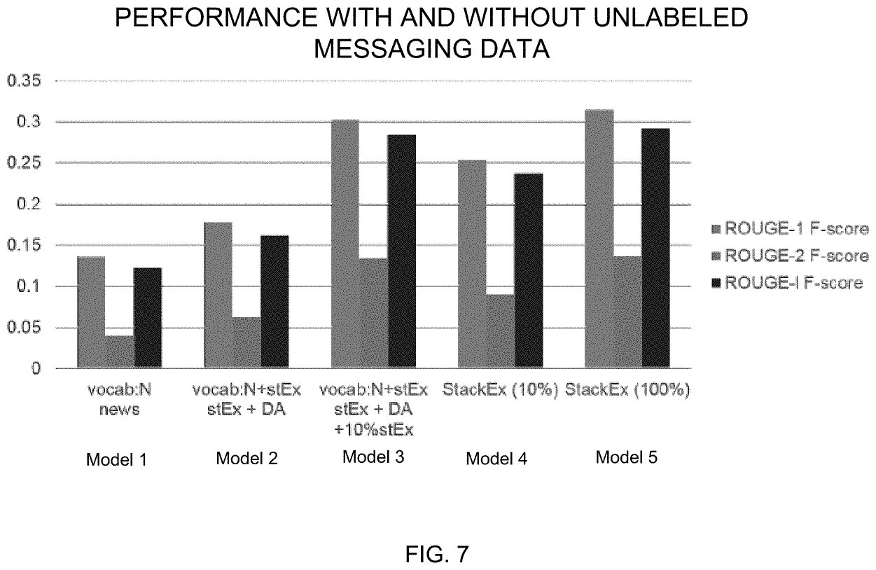

FIG. 7 provides a graph of results of a second experiment involving example implementations of the present application. As illustrated, this second experimental data set compares the performance when no labeled data is available. Again, titles are generated for unlabeled messaging data in a chat platform. The models compared from left to right are:

(1) the baseline performance model (model 1) described with respect to FIG. 6 above;

(2) a model with an expanded, combined vocabulary of the most frequent terms from both the training news data and the unlabeled messaging data except rather than training directly on news, first domain adaptation is used to adapt the synthetic Stack Exchange data and news data (model 4 from FIG. 6);

(3) the model (2) of FIG. 7 fine-tuned with 10% of a labeled message data set (140 k post and title pairs);

(4) the baseline mode (model 1 of FIG. 6) using 10% of the labeled message data set (140 k post and title pairs);

(5) the baseline mode (model 1 of FIG. 6) using 100% of the labeled message data set (140 k post and title pairs).

As illustrated in FIG. 7 and Table 2 below, (1) the performance using labeled training data (models 4 and 5) is much better than when no labeled message data is available and (2) the performance when only 10% of the labeled training data (model 4) is used is quite a bit lower than when all of the labeled training data (model 5 is used.

Model 3 is the best combined model which is then fine-tuned with 10% of the labeled Stack Exchange training data. Note that this model noticeably improves the performance over using 10% of the labeled training message data (4) alone.

TABLE 2
First Experimental results illustrated in FIG. 6

| | | ROUGE-1 | ROUGE-1 | ROUGE-1 |
|---|---|---|---|---|
| Vocabulary | Training Data | F-score | F-score | F-score |
| vocab: News | News | 0.1365 | 0.0402 | 0.1227 |
| vocab: News + | sStEx + DA | 0.1778 | 0.0622 | 0.1615 |
| stEx | | | | |
| vocab: News + | sStEx + DA + 10% | 0.3022 | 0.134 | 0.2846 |
| stEx | stEx | | | |
| | StackEx (10%) | 0.2542 | 0.0901 | 0.2373 |
| | StackEx (100%) | 0.3149 | 0.137 | 0.2922 |

Example Computing Environment

FIG. 8 illustrates an example computing environment 800 with an example computer device 805 suitable for use in some example implementations. Computing device 805 in computing environment 800 can include one or more processing units, cores, or processors 810, memory 815 (e.g., RAM, ROM, and/or the like), internal storage 820 (e.g., magnetic, optical, solid state storage, and/or organic), and/or I/O interface 825, any of which can be coupled on a communication mechanism or bus 830 for communicating information or embedded in the computing device 805.

Computing device 805 can be communicatively coupled to input/interface 835 and output device/interface 840. Either one or both of input/interface 835 and output device/interface 840 can be a wired or wireless interface and can be detachable. Input/interface 835 may include any device, component, sensor, or interface, physical or virtual, which can be used to provide input (e.g., buttons, touch-screen interface, keyboard, a pointing/cursor control, microphone, camera, braille, motion sensor, optical reader, and/or the like).

Output device/interface 840 may include a display, television, monitor, printer, speaker, braille, or the like. In some example implementations, input/interface 835 (e.g., user interface) and output device/interface 840 can be embedded with, or physically coupled to, the computing device 805. In other example implementations, other computing devices may function as, or provide the functions of, an input/interface 835 and output device/interface 840 for a computing device 805. These elements may include, but are not limited to, well-known AR hardware inputs so as to permit a user to interact with an AR environment.

Examples of computing device 805 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, server devices, other computers, information kiosks, televisions with one or more processors embedded therein and/or coupled thereto, radios, and the like).

Computing device 805 can be communicatively coupled (e.g., via I/O interface 825) to external storage 845 and network 850 for communicating with any number of networked components, devices, and systems, including one or more computing devices of the same or different configuration. Computing device 805 or any connected computing device can be functioning as, providing services of, or referred to as a server, client, thin server, general machine, special-purpose machine, or another label.

I/O interface 825 can include, but is not limited to, wired and/or wireless interfaces using any communication or I/O protocols or standards (e.g., Ethernet, 802.11xs, Universal System Bus, WiMAX, modem, a cellular network protocol, and the like) for communicating information to and/or from at least all the connected components, devices, and network in computing environment 800. Network 850 can be any network or combination of networks (e.g., the Internet, local area network, wide area network, a telephonic network, a cellular network, satellite network, and the like).

Computing device 805 can use and/or communicate using computer-usable or computer-readable media, including transitory media and non-transitory media. Transitory media includes transmission media (e.g., metal cables, fiber optics), signals, carrier waves, and the like. Non-transitory media includes magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computing device 805 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 810 can execute under any operating system (OS) (not shown), in a native or virtual environment. One or more applications can be deployed that include logic unit 855, application programming interface (API) unit 860, input unit 865, output unit 870, model training unit 875, titled generation unit 880 and domain adaption unit 885, and inter-unit communication mechanism 895 for the different units to communicate with each other, with the OS, and with other applications (not shown).

For example, the model training unit 875, titled generation unit 880 and domain adaption unit 885 may implement one or more processes shown in FIGS. 1 James and 2. The described units and elements can be varied in design, function, configuration, or implementation and are not limited to the descriptions provided.

In some example implementations, when information or an execution instruction is received by API unit 860, it may be communicated to one or more other units (e.g., model training unit 875, titled generation unit 880 and domain adaption unit 885). For example, the model training unit 875 may generates a title generation computer model based on received training data and/or extracted domain vocabularies and provide the generated title generation computer to the domain adaption unit 885. Further, the domain adaption unit 885 may adapt the provided title generation computer model to new domains and provide the title generation computer model to the title generation unit 880. Further, the title generation units 880 may apply the generated and adapted title generation computer model to one or more documents received by the input unit 865 and generate a UI with the one or more documents via the output unit 870.

In some instances, the logic unit 855 may be configured to control the information flow among the units and direct the services provided by API unit 860, input unit 865, model training unit 875, titled generation unit 880 and domain adaption unit 885 in some example implementations described above. For example, the flow of one or more processes or implementations may be controlled by logic unit 855 alone or in conjunction with API unit 860.

Although a few example implementations have been shown and described, these example implementations are provided to convey the subject matter described herein to people who are familiar with this field. It should be understood that the subject matter described herein may be implemented in various forms without being limited to the described example implementations. The subject matter described herein can be practiced without those specifically defined or described matters or with other or different elements or matters not described. It will be appreciated by those familiar with this field that changes may be made in these example implementations without departing from the subject matter described herein as defined in the appended claims and their equivalents.

What is claimed is:

1. A method of generating titles for documents in a storage platform, the method comprising:
receiving a plurality of documents, each document having associated content features;
applying a title generation computer model to each of the plurality of documents to generate a title based on the associated content features;
appending the generated title to each of the plurality of documents, wherein the title generation computer model is created by training a neural network using a combination of:
a first set of unlabeled data from a first domain related to content features of the plurality of documents; and
a second set of pre-labeled data from a second domain different from the first domain.

2. The method of claim 1, wherein the neural network is trained by combining a vocabulary extracted from the first set of data with a vocabulary extracted from the second set of data.

3. The method of claim 1, the training of the neural network further comprising:
extracting content features from the first set of data;
generating a first set of preliminary titles based on the extracted content features from the first set of data; and
training the neural network on the first domain using the generated preliminary titles and the first set of data.

4. The method of claim 3, wherein the generating a first set of preliminary titles comprises extracting a portion of content features from the text from each of the plurality of documents in the first set of unlabeled data.

5. The method of claim 3, the training of the neural network further comprising adapting the trained neural network to the second domain based on the pre-labeled data of the second set and combined vocabularies extracted from the first set of data and the second set of data.

6. The method of claim 5, wherein adapting the trained neural network to the second domain based on the pre-labeled data of the second set and the combined vocabularies extracted from the first set of data and the second set of data comprises performing a secondary classification task to keep the trained neural network aligned with the pre-labeled data of the second set.

7. The method of claim 5, the training of the neural network further comprising further re-training the neural network on the second domain using the generated preliminary titles and the second set of data; and
adapting the re-trained neural network to the first domain based on the first set of data and the combined vocabularies extracted from the first set of data and the second set of data.

8. The method of claim 7, further comprising generating a user interface (UI) providing a search function based on the generated titles; and
displaying at least one document in response to search request received through the UI based on the generated titles.

9. The method of claim 8, further comprising receiving a selection request through the UI;
updating the title generation computer model based on the received selection request.

10. A non-transitory computer readable medium having stored therein a program for making a computer execute a method of generating titles for documents in a storage platform, the method comprising:
receiving a plurality of documents, each document having associated content features;
applying a title generation computer model to each of the plurality of documents to generate a title based on the associated content features;
appending the generated title to each of the plurality of documents, wherein the title generation computer model is created by training a neural network using a combination of:
a first set of unlabeled data from a first domain related to content features of the plurality of documents; and
a second set of pre-labeled data from a second domain different from the first domain.

11. The non-transitory computer readable medium of claim 10, wherein the neural network is trained by combining a vocabulary extracted from the first set of data with a vocabulary extracted from the second set of data.

12. The non-transitory computer readable medium of claim 10, the training of the neural network further comprising:
extracting content features from the first set of data;
generating a first set of preliminary titles based on the extracted content features from the first set of data; and
training the neural network on the first domain using the generated preliminary titles and the first set of data.

13. The non-transitory computer readable medium of claim 12, the training of the neural network further comprising adapting the trained neural network to the second domain based on the pre-labeled data of the second set and combined vocabularies extracted from the first set of data and the second set of data

14. The non-transitory computer readable medium of claim 13, wherein adapting the trained neural network to the second domain based on the pre-labeled data of the second set and the combined vocabularies extracted from the first set of data and the second set of data comprises performing a secondary classification task to keep the trained neural network aligned with the pre-labeled data of the second set.

15. The non-transitory computer readable medium of claim 13, the training of the neural network further comprising further re-training the neural network on the second domain using the generated preliminary titles and the second set of data; and
adapting the re-trained neural network to the first domain based on the first set of data and the combined vocabularies extracted from the first set of data and the second set of data.

16. The non-transitory computer readable medium of claim 15, further comprising generating a user interface (UI) providing a search function based on the generated titles; and
displaying at least one document in response to search request received through the UI based on the generated titles.

17. A computing device comprising:
a memory storing a plurality of documents; and
a processor configured to perform a method of generating titles for the plurality of documents, the method comprising:
receiving a plurality of documents, each document having associated content features;
applying a title generation computer model to each of the plurality of documents to generate a title based on the associated content features;
appending the generated title to each of the plurality of documents, wherein the title generation computer model is created by training a neural network using a combination of:
a first set of unlabeled data from a first domain related to content features of the plurality of documents; and
a second set of pre-labeled data from a second domain different from the first domain.

18. The computing device of claim 17, wherein the training of the neural network further comprises:
extracting content features from the first set of data;
generating a first set of preliminary titles based on the extracted content features from the first set of data; and
training the neural network on the first domain using the generated preliminary titles and the first set of data.

19. The computing device of claim 18, the training of the neural network further comprises adapting the trained neural network to the second domain based on the pre-labeled data of the second set and combined vocabularies extracted from the first set of data and the second set of data.

20. The computing device of claim 19, the training of the neural network further comprises re-training the neural network on the second domain using the generated preliminary titles and the second set of data; and
adapting the re-trained neural network to the first domain based on the first set of data and the combined vocabularies extracted from the first set of data and the second set of data.
